(19) United States
(12) Patent Application Publication
(10) Pub. No.: US 2001/0018683 A1
(43) Pub. Date: Aug. 30, 2001

(54) High-speed audio/video information server and magnetic disk device extension method thereof

(75) Inventor: Kenji Saito, Osaka (JP)

Correspondence Address: GREENBLUM & BERNSTEIN, P.L.C., 1941 ROLAND CLARKE PLACE, RESTON, VA, 20191, US

(73) Assignee: MATSUSHITA ELECTRIC INDUSTRIAL CO. LTD., Osaka (JP)

(21) Appl. No.: 09/767,911

(22) Filed: Jan. 24, 2001

(30) Foreign Application Priority Data
Jan. 26, 2000 (JP) 2000-16603

(51) Int. Cl. G06F 7/00

(52) U.S. Cl. 707/1

(57) ABSTRACT

An HDD array is extended in a high-speed AV information server and then a restructuring instruction (41) is generated and restructuring operation (42) is executed If a reproduction request (43) is issued to storage information which is being restructured information processing (44) for interrupting the restructuring operation is carried out and a display (29) of a region which is being restructured is passed so as to reproduce the storage information. At the end of reproduction (47) after executing the reproduction operation (46), the reproduction operation (48) is resumed to thereby allow the access even while storage information is being restructured.

### BACKGROUND OF THE INVENTION

1. Field of the Invention

The present invention generally relates to a high-speed audio/video (AV) information server for recording and reproducing AV information at a high speed, and relates to a method of changing HDD's in a high-speed AV information server. The method is in particular directed to a magnetic disk device extension method capable of extending magnetic disk devices in a high-speed AV information server.

2. Description of the Prior Art

In recent years, high-speed, high-performance computers have appeared and it becomes, therefore, possible to convert and compress an audio/video (referred to as “AV” hereinafter) information signal into a digital information signal and to process the digital information by means of a computer system as in the same manner as computer information. Namely, there is proposed an AV information server for recording and reproducing a high-vision AV information signal by way of adding a high-vision mode recording and reproduction function to a recording and reproduction apparatus used in a current standard mode (NTSC). This AV information server is equipped with a plurality of magnetic disk devices which are operated in parallel, thereby realizing transfer of required information quantity within a unit time.

Now, a general construction of the above-stated AV information server will be schematically described. The AV information server includes a plurality of magnetic disk devices (also referred to as “HDD arrays”) each of which is equipped with a plurality of magnetic hard disk drives (HDD's). This AV information server is also equipped with e.g. three standard density (SD) CODEC terminals for current NTSC and e.g. two high density AD) CODEC terminals for a high-vision mode.

Furthermore, necessary number (e.g., four) magnetic disk devices can be added at need, together with SD CODEC terminals and HD CODEC terminals thereof added to the AV information server accordingly. The SD CODEC terminals and HD CODEC terminals are generally referred to as “CODEC terminals”.

However, if magnetic disk devices are extended as stated above, it is required to equally distribute information transfer quantity to a plurality of magnetic disk drives so as to obtain necessary information transfer quantity for the respective magnetic disk devices while the magnetic disk devices are being operated in parallel. Therefore, it is necessary to carry out an operation for reading AV information already recorded and dividing and recording the read information again (which the operation is referred to as “restructure” or “restructuring operation” hereinafter). If the already recorded AV information is used as it is without a restructuring operation, the load of the existing magnetic disk devices excessively increases. If the existing magnetic disk devices are frequently subjected to access such as write/read operations, there cannot be secured information transfer quantity required by a group of CODEC terminals including added CODEC terminals which have been extended to obtain appropriate information transfer quantity. For that reason, it is necessary to execute the restructuring operation. During the restructuring operation, it is disadvantageous that the magnetic disk devices cannot be accessed from the CODEC terminals because of executing the restructuring operation of the information in the respective magnetic disk devices, and there is inherently involved with a problem of access interruption in the conventional technique.

### SUMMARY OF THE INVENTION

The present invention has been made to solve the above-stated conventional problem and is intended to provide a high-speed AV information server and a magnetic disk device extension method thereof capable of accessing magnetic disk devices from CODEC terminals even if a storage information restructuring operation is being carried out according to the extension of magnetic disk devices.

A high-speed AV information server and a magnetic disk device extension method thereof according to one aspect of the present invention will be schematically described hereinafter.

According to the present invention, the high-speed AV information server acts as an AV information recording and reproduction apparatus wherein a management terminal, a plurality of CODEC terminals and a plurality of magnetic disk devices are connected using an FC switching hub and A/V information transferred via a high-speed network (to be referred to as “fiber channel” or “FC (Fiber Channel)” hereinafter) through the CODEC terminals is recorded and reproduced. When one or more magnetic disk devices are extended so as to increase information transfer quantity, the restructuring operation for restructuring the AV information already recorded on the already existing magnetic disk devices is executed.

According to the present invention, even while the restructuring operation is being carried out, it is possible to access the high-speed AV information server through the CODEC terminals. In the restructuring operation, the AV information already recorded on the magnetic disk devices is read and temporarily stored in a memory or the like within the management terminal or other external temporary storage unit and then the temporarily storage information is divided and recorded equally in quantity to all of the magnetic disk devices including the extended magnetic disk devices. In one aspect of the present invention, the restructuring operation is executed by the management terminal.

A division unit of AV information is usually a unit of one frame. However, in case of MPEG scheme compression, information is not compressed in frame units and an MPEG division unit (GOP)is used as the division unit according to the MPEG scheme. According to the present invention, the restructuring operation is managed in division units of a restructuring completed portion and a restructuring unexecuted portion. If an access request to access the AV information which is being restructured is issued, then the restructuring operation is interrupted, both the restructuring completed portion and the restructuring unexecuted portion are fed to the CODEC terminal which has issued the access request. The CODEC terminal accesses the AV information while recognizing that the constitution of the magnetic disk devices differ between the restructuring completed portion and the restructuring unexecuted portion, thereby making it possible to reproduce the AV information.

The reproduction is ended by operation for closing an AV information file by the CODEC terminals and the management terminal recognizes the end of the reproduction. After the completion of reproducing the AV information by the CODEC terminals, the restructuring operation is continued again. During the restructuring operation, there are two methods of carrying out read operation and write operation, one is a method of simultaneously carrying out read operation and write operation and early completing the restructuring operation and the other is a method of executing the read operation and the write operation in a time division manner.

During the read operation, if the read operation and the write operation are simultaneously carried out, information read from the magnetic disk devices is written to a memory within the management terminal irrespectively of the state of the write operation. During the write operation, on the other hand, if information exist in the memory, the information is written to the magnetic disk devices. In that case, information transfer quantity required for the restructuring operation is calculated, assuming that the read and write operations are simultaneously executed.

In case of time-division restructuring operation according to a method of reading a certain quantity of information and thereafter writing this read information, the information transfer quantity required for the restructuring operation is calculated assuming that the read operation and the write operation are not simultaneously executed. The restructuring operation is carried out by transfer of the information to and from the memory in the management terminal and it is necessary to manage the information transfer as a high-speed transfer such as a transfer of high-vision television information. The CODEC terminals can access information other than the AV information which is being restructured even if the restructuring is being carried out. However, if the total of the information transfer quantity by the restructuring operation and that by access from the CODEC terminals which are carried out simultaneously, exceeds an information transfer upper limit, the restructuring operation should be interrupted.

The high-speed AV information server has an intermediate performance between that having the information transfer quantity before extending the magnetic disk device, and that after the completion of the restructuring operation until the restructuring operation is completed, and it is preferable that the server operates with almost the same performance as that before extending the magnetic disk device until the completion of the restructuring operation.

A high-speed AV information server according to the present invention comprises: a plurality of magnetic disk devices having recording regions storing AV information in division state inputted by way of a communication switching device; at least one CODEC terminals for inputting and outputting the AV information to and from the magnetic disk devices; and a management terminal controlling the magnetic disk devices and CODEC terminals and managing the recording regions of the magnetic disk devices; wherein the management terminal includes: a restructuring unit executing a restructuring operation of the AV information when another magnetic disk device is additionally extended; and an interruption processing unit for interrupting the restructuring operation when a reproduction request is issued from one of the CODEC terminals to the storage information which is under being restructured.

In this construction, each of the CODEC terminals converts an inputted analog AV information signal into a digital information signal and divides and records the digital information in the magnetic disk devices based on management information of the management terminal, and reads the digital information divided and recorded in the magnetic disk devices, converting the digital information into an analog information signal to be outputted. The communication switching device switchably connecting the management terminal, magnetic disk devices and CODEC terminals.

The restructuring unit executes the restructuring operation, so that the AV digital information recorded in the magnetic disk devices before extending another magnetic disk device is divided and recorded into all of the magnetic disk devices including the extended magnetic disk device.

During the interruption of the restructuring operation when a reproduction request is issued, the AV storage digital information divided and recorded in a restructure completed region and in a restructure unexecuted region of all the magnetic disk devices are read and fed to the CODEC terminal.

The high-speed AV information server further comprises a restructure resuming unit for resuming the interrupted restructuring operation to be continued when completing the requested reproduction operation.

Thus, the present invention has an effect that the CODEC terminals can be operated in response to a CODEC terminal operation request without recognizing that the restructuring operation is being carried out

The management terminal may include: an information transfer quantity setting unit for setting an upper limit of information transfer quantity from information transfer quantity of each CODEC terminal and setting an information transfer quantity required for the restructuring operation under management of the management terminal.

In this arrangement, if total information transfer quantity of the information transfer quantity by operation of the CODEC terminals and the information transfer quantity by the restructuring operation exceeds the upper limit during the restructuring operation, then the restructuring operation is interrupted to respond to the operation request from the CODEC terminal.

With this constitution, the present invention can advantageously operate the CODEC terminal even if restructuring operation is being carried out following the extension of magnetic disk devices.

According another aspect of the present invention, a method of extending a magnetic disk device to a high-speed AV information server comprises: storing AV information to a plurality of magnetic disk devices in division state; inputting and outputting the AV information to and from the magnetic disk devices; and executing a restructuring operation of the AV information when another magnetic disk device is additionally extended; and interrupting the restructuring operation when a reproduction request is issued to the storage information which is under being restructured.

The method comprises a step of converting an inputted analog AV information signal into a digital information signal and dividing and recording the digital information in the magnetic disk devices based on management information of a management terminal, and reading the digital information divided and recorded in the magnetic disk devices, converting the digital information into an analog information signal to be outputted.

The restructuring step executes the restructuring operation, so that the AV digital information recorded in the magnetic disk devices before extending another magnetic disk device is divided and recorded into all of the magnetic disk devices including the extended magnetic disk device.

During the interruption of the restructuring operation when a reproduction request is issued, the method includes a step of reading the AV storage digital information divided and recorded in a restructure completed region and in a restructure unexecuted region of all the magnetic disk devices.

The method further comprises a restructure resuming step for resuming the interrupted restructuring operation to be continued when completing the requested reproduction operation.

With this method according to the present invention, the CODEC terminal can be advantageously operated even if restructuring operation is being carried out following the extension of magnetic disk devices.

The method further may include: an information transfer quantity setting step for setting an upper limit of information transfer quantity from information transfer quantity and setting an information transfer quantity required for the restructuring operation under management of the management terminal.

In this method, if total information transfer quantity of the information transfer quantity by accessing and the information transfer quantity by the restructuring operation exceeds the upper limit during the restructuring operation, then the restructuring operation is interrupted to respond to the operation request.

With this constitution, if the information transfer quantity exceeds a limit set according to the number of usable CODEC terminals, the restructuring operation is automatically stopped. Thus, the present invention has a function that the CODEC terminals can be operated in response to a CODEC terminal operation request without recognizing that the restructuring operation is being carried out.

### BRIEF DESCRIPTION OF THE DRAWINGS

These and other objects and features of the present invention will be readily understood from the following detailed description taken in conjunction with preferred embodiments thereof with reference to the accompanying drawings, in which like parts are designated by like reference numerals and in which:

FIG. 1 shows the basic constitution of a high-speed AV server in one embodiment of the present invention;

FIG. 2 is an explanatory view showing an example managing HDD arrays by the management terminals of the high-speed AV information server in the embodiment according to the present invention;

FIG. 3 is a view showing the constitution of high-speed AV information server to which HDD arrays and CODEC terminals are extended;

FIG. 4 is a view showing an example of recording regions so as to describe a recording region state before HDD arrays are extended to the high-speed AV information server;

FIG. 5 is a view showing an example of recording regions for describing a state in which storage information restructuring operation is being carried out if HDD arrays are extended to the high-speed AV information server;

FIG. 6 is a view showing a state in which HDD arrays are extended to the high-speed AV information server and in which the storage information restructuring operation of the server has been completed;

FIG. 7 is an explanatory view in a case of interrupting storage information restructuring operation after extending HDD arrays to the high-speed AV information server; and

FIG. 8 is an explanatory view for describing a case of interrupting storage information restructuring operation due to the limitation of information transfer quantity after extending HDD arrays to the high-speed AV information server.

### DESCRIPTION OF THE PREFERRED EMBODIMENTS

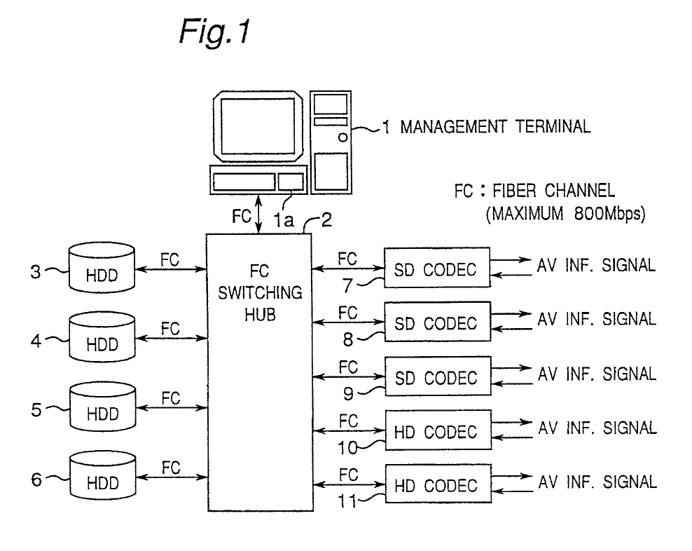

A preferred embodiment of the present invention will be described in detail hereinafter with reference to FIGS. 1 through 8.

First, a basic constitution of a high-speed AV information server in one embodiment of the present invention will be described with reference to FIG. 1.

In FIG. 1, the high-speed AV information server includes a plurality of magnetic disk devices (depicted as HDD arrays 3 to 6 in FIG. 1) and each of the magnetic disk devices is equipped with a plurality of magnetic hard disk drives (HDD's) and acts as a device having information protection function such as RAID (redundant information processing function). Each magnetic disk device includes a plurality of HDD units and therefore has high information storage and transfer capability even if used solely. This AV information server is also equipped with, for example, three SD CODEC terminals 7-9 for current NTSC scheme and two HD CODEC terminals 10-11 for high-vision scheme. Furthermore, additional magnetic disk devices of necessary number (e.g., four) can be provided at need, and accordingly, for example, three SD CODEC terminals and, for example, two HD CODEC terminals can be extended in the AV information server.

In FIG. 1, the AV information server includes a management terminal 1 which manages recording files, recording regions and non-recording regions of hard disk drive arrays (“HDD arrays” hereinafter) 3, 4, 5 and 6, and an FC switching hub 2 of fiber channels (FC).

The management terminal 1 includes a memory la as a temporary storage unit, and functions of the memory la are described below.

During a restructuring operation, the AV information already recorded on the magnetic disk devices is read and temporarily stored in the memory 1a and the AV information is divided and recorded to all magnetic disk devices including the extended magnetic disk devices.

If a read operation and a write operation are simultaneously carried out, the information read from the magnetic disk devices is temporarily stored in the memory la within the management terminal during the read operation irrespectively of the state of the write operation.

During the write operation, on the other hand, if information exist in the memory, the information is written (i.e., recorded) to the magnetic disk devices. In that case, information transfer quantity required for the restructuring operation is calculated assuming that the read and write operations are simultaneously executed.

In case of time-division restructuring operation where a certain quantity of information is read and thereafter this read information is written, the information transfer quantity required for the restructuring operation is calculated assuming that the read operation and the write operation are not simultaneously executed. The restructuring operation is carried out by transfer of the information to and from the memory 1a within the management terminal 1 and it is necessary to manage the information transfer as a high-speed transfer such as a transfer of high-vision television information. The CODEC terminals can access information other than the AV information which is being restructured even if the restructuring is being carried out now.

The FC switching hub 2 serves as a communication switching device which has a plurality of FC connection terminals, which connects an FC connection terminal which issues a request for communication to a designated FC connection terminal in response to a communication request for designating a communication other party from an arbitrary FC connection terminal, thereby allowing establishment of communication between these FC connection terminals. The HDD arrays 3, 4, 5 and 6 are magnetic disk devices each of which includes a plurality of magnetic disks. Each of the magnetic disk devices can transfer information at a high speed by operating a plurality of the magnetic disk devices in parallel.

Each of the SD CODEC terminals 7, 8 and 9 converts (A/D-converts and compresses) a Japan-US standard television signal (i.e., standard density (SD) television signal) into a digital information signal and outputs the digital information to the fiber channels (FC). In addition, the SD CODEC terminals receive digital data from the fiber channels (FC), convert (expand and D/A-convert) the received data into an SD television signal and outputs the SD television signal.

Meanwhile, each of the HD CODEC terminals 10 and 11 inputs a high-vision television signal of high density (HD), converts (A/D-converts and compresses) the high-vision signal into digital information and outputs an HD television signal to the fiber channels (FC). Further, the HD CODEC terminals convert (expand and D/A-convert) the input information from the fiber channels (FC) into an HD television signal and outputs the HD television signal. The SD CODEC's and HD CODEC's are generally referred to as CODEC terminals or simply CODEC's hereinafter.

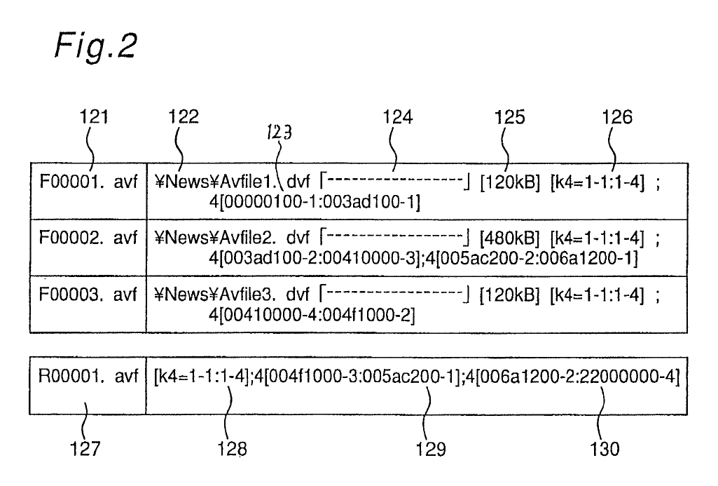

Next, with reference to FIG. 2, description will be given to an example of managing the HDD arrays 3-6 by the management terminal 1 in the high-speed AV information server of a preferred embodiment. It is assumed that the management terminal 1 shown in FIG. 1 is run on an ordinarily used operation system (OS) and manages the HDD arrays 3 to 6 using a file system on the operation system.

As an initial management operation for the HDD arrays 3 to 6, there is created an unused region file of R00001.avf denoted by reference numeral 127 for management of an unused region using the memory a of the management terminal 1. According to this unused region file 127, [k4=1-1:1-4] denoted by reference numeral 128 indicates a constitution type having four magnetic disk devices, and 4[00000100-1: 22000000-4] and the like denoted by reference numerals 129 and 130 show an unused regions. Here, 00000100 means a block address of the smallest capacity value in an HDD array and 22000000 is an example of showing the maximum value of the capacity of the HDD array by a block address. −1, −2, −3 and −4 indicate the first, second, third and fourth HDD arrays 3, 4, 5 and 6, respectively.

The block address is represented in units of block sizes (normally an address in byte units is used) each of which units is set (e.g., at 4 kB) while the minimum information access unit is one block size. The block size of the minimum information access unit is predetermined by the management terminal, separately.

Reference numeral 121 denotes file names F00001.avf to F00003.avf of the management terminal each of which describes AV information recorded therewith. A file is created when a recording request is issued from the SD CODEC terminals (7 to 9 in FIG. 1). That is to say, request items from the CODEC terminals include an AV file name, expected program length, frame size and the like. If the expected program length is unknown, it may be blank. When the expected program length is blank, a virtual program length is established in the management terminal 1 to secure a recording region corresponding to the virtual program length to thereby execute a recording operation. If there is a virtual program length designated by a user in the management terminal, the designated value of, e.g., five minutes is set up as the virtual program length. Whereas, if there is no designated virtual program length, a value of, e.g., one minute is established as the virtual program length to secure a recording region to thereby execute the recording operation.

As an AV information folder and file name 122 in the management file, a folder and file name notified from the CODEC terminal are described. This information 122 of a folder and file name is described for managing AV information. With reference to the folder and file name 122, the AV information is reproduced by designating the file name information in a reproduction operation.

Reference numeral 123 denotes AV information recording region information which indicates a region in which the folder and file name Avfilel.dvf denoted by 122 of the AV information is recorded. Reference numeral 124 denotes information of such as a title of the AV information, which is recognized by being bracketed Reference numeral 125 denotes a frame size which is set by the CODEC terminals (7 to 11 in FIG. 1) and informed to the management terminal 1. Reference numeral 126 denotes a HDD array type ([k4=1-1:1-4]) which indicates that four magnetic disk devices are used in the server.

In response to a recording request from CODEC terminals 7 to 11, the management terminal 1 notifies the CODEC terminals 7 to 11 of the region information and block size secured in the HDD arrays 3 to 6. Upon receipt of the region information and block size from the management terminal 1, the CODEC terminals 7 to 11 record the information in the HDD arrays 3 to 6 in the order of the numbers. The quantity of one frame information is written to 30 (in decimal system) blocks if the one frame size is 120 KB under the condition that the block size is 4 kB. If one frame size is 480 kB, one frame information is written to 120 (in decimal system) blocks.

The example of FIG. 2 shows a case where the recording of AV information in a file name F00003.avf 121 is started while the information is recorded in the file name F00002.avf 121. Since the program length of the file name F00002.avf 121 becomes longer than the expected program length, the CODEC terminals (7 to 11) request an additional region before completing the recording in the given region The management terminal 1 secures a region after the region secured in the file name F00003.dvf 121, for the file name F00002.avf 121. The recording is completed in a state that the program length of the file name F00003.avf 121 is shorter than the expected program length. In this example, the file name F00001.avf indicates that one piece of AV information is recorded in one recording region 123, and the file name F00002.avf indicates that another piece of AV information is recorded in two separate recording regions, and the file name F00003.avf indicates that further another piece of AV information is recorded in one recording region. Thus, the unused region file R00001.avf indicates that the unused regions 129 and 130 are recognized as recordable free spaces skipped separately from each other.

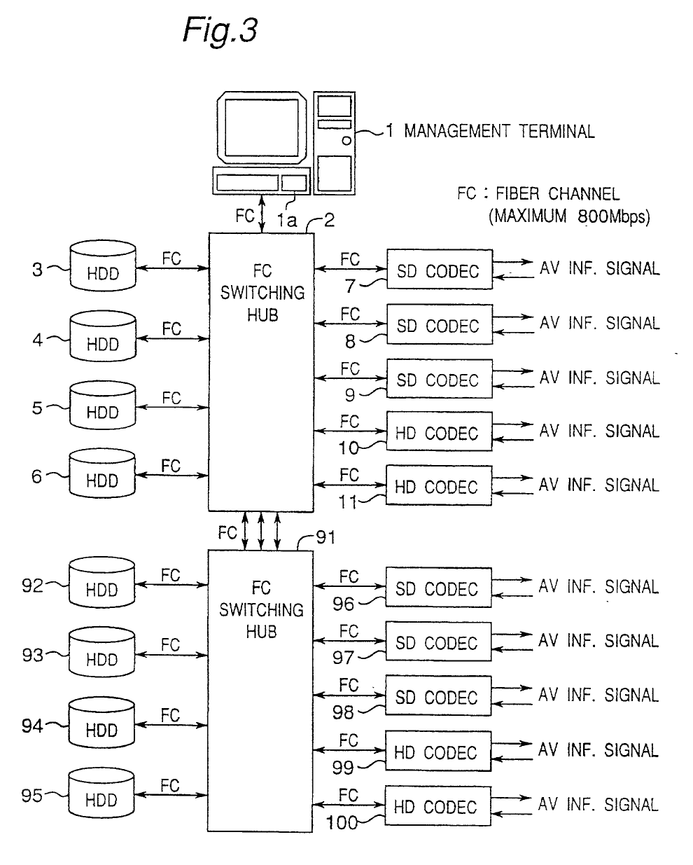

Next, with reference to FIG. 3, description will be given to the high-speed AV information server of a preferred embodiment to which HDD arrays and CODEC terminals are extended.

In FIG. 3, an FC switching hub 91 is an extended hub which is connected to the FC switching hub 2 and managed by the management terminal 1 in the same manner as in the case of the FC switching hub 2. HDD arrays 92 to 95 are extended HDD arrays and the recording files and recording regions thereof are managed by the management terminal 1. SD CODEC's 96 to 98 are extended SD CODEC terminals and HD CODEC's 99 to 100 are extended HD CODEC terminals.

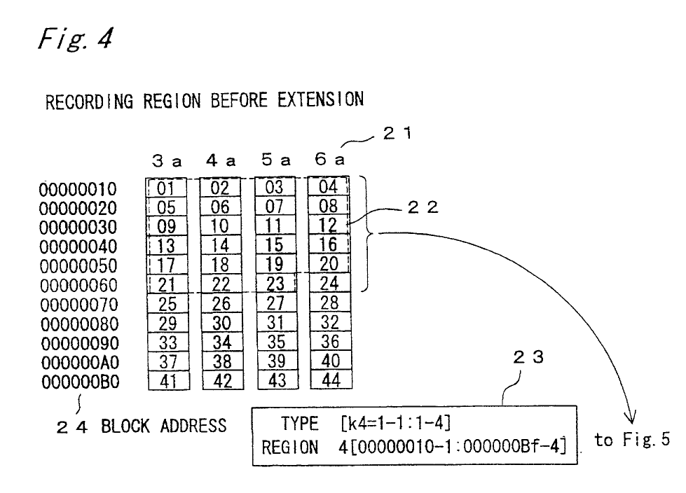

Next, with reference to FIG. 4, description will be given to a state of a storage region when HDD arrays are extended to the high-speed AV information server in the preferred embodiment of the present invention. FIG. 4 shows an example of a storage region for describing a storage region state before HDD arrays are extended to the high-speed AV information server.

In FIG. 4, reference numeral 21 represents the constitution of the recording regions 3a, 4a, 5a and 6a of the HDD arrays 3, 4, 5 and 6 shown in FIG. 1, respectively. A restructuring operation region denoted by a reference numeral 22 shows a recording state of a part of the recorded storage AV information. Each number of “01” to “23” depicted in the restructuring operation region 22 indicates each divided frame of the storage information recorded in the HDD arrays. In this case, the restructuring operation region 22 records the frames ranging from the 1st to 23-th frame numbers 01 to 23.

Further, in order to simplify the description, FIG. 4 shows an example of the storage information consisting of 44 frames. The recording region of this storage information is descried as shown in a recording region display portion denoted by reference numeral 23. The recording region display portion 23 indicates that a type of the HDD arrays 3 to 6 is a constitution of four magnetic disk devices by referring to [k4=1-1:1-4] and displays that the recording region of this storage information is 4[00000010-1:000000bf-4]. Reference numeral 24 denotes the block addresses of the HDD arrays 3 to 6 which are expressed as a group of figures such as 00000010 to 00000090 and 000000A0 and 000000B0.

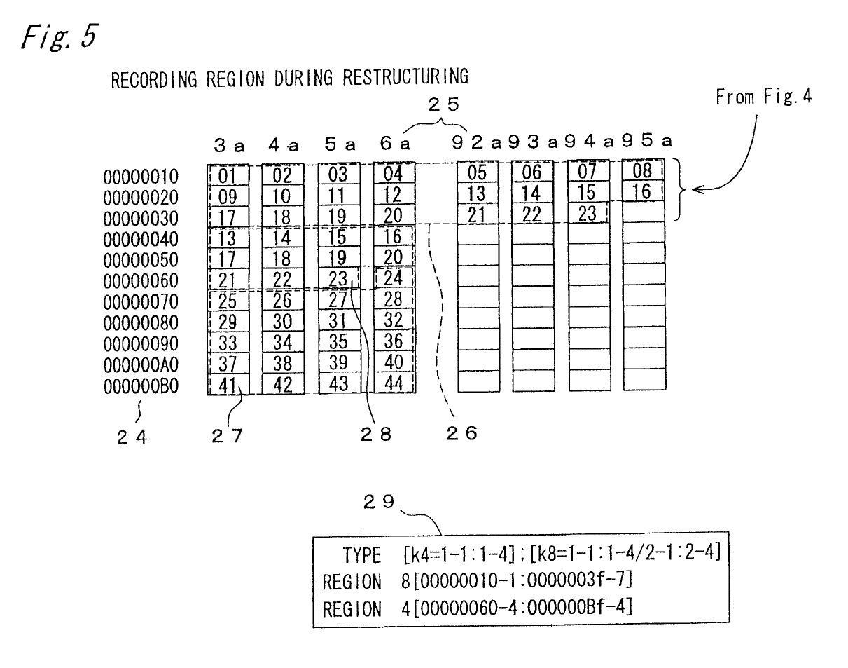

Next, with reference to FIG. 5, description will be given to a halfway state of the restructuring operation in which the storage information restructuring operation is being now carried out after HDD arrays are extended to the high-speed AV information servers FIG. 5 shows an example of a recording region in a halfway state that the storage information restructuring operation is being carried out after HDD arrays are extended to the high-speed AV information server. This restructuring operation of the storage information is executed by the management terminal 1 as to be described below.

In FIG. 5, reference numeral 25 denotes a structure of the recording regions 3a to 6a and expanded recording regions 92a to 95a of the HDD arrays 3 to 6 and 92 to 95, respectively, after the HDD arrays 92 to 95 are added as shown in FIG. 3. Reference numeral 26 denotes a restructuring operation region having the frames of frame numbers 01 to 23 recorded which the region indicates a restructure completed portion. Reference numeral 27 denotes a restructure unexecuted region in which the restructuring operation has not been set up. Reference numeral 28 denotes a restructure uncompleted region which shows a halfway state region of the restructuring operation, where previous storage information data before completion of the restructuring operation remains stored. No frames for restructure are written to this region 28 yet by the present restructuring operation, and therefore the region 28 can not be regarded yet as a recodable region although other remaining data will be able to be written to the restructure uncompleted region 28 by proceeding the restructuring operation. Thus, in the halfway state 28 of the restructuring operation, the frames 13 to 23 in the restructure uncompleted region 28 are read and written to the corresponding frame positions 13 to 23 respectively in the restructure completed region 26. In this process, although the frames 13 to 23 in the restructure uncompleted region 28 are read, the information of these frames remains as it is because these frames are not erased in the reading. By proceeding the reading of the subsequent frames below 24 and rewriting the previous frames 13 to 23 therefor for the restructuring operation, the restructure uncompleted region 28 is changed to be regarded as a restructure completed region, i.e., recordable region.

The recording region of the storage information in a state during a restructuring operation shown in FIG. 5 is displayed as shown in a region display portion denoted by reference numeral 29. The region display portion 29 displays that two types of magnetic disk devices are used as the constitution of the magnetic disk devices, i.e., [k4=1-1:1-4] showing the constitution of four HDD arrays 3 to 6 before extension and [k8=1-1:1-4/2-1:2-4] showing the constitution of eight HDD arrays including the added HDD arrays 92 to 95. In the region display portion 29 shown in FIG. 5, 8[00000010-1:0000003f-7] indicates the restructuring operation region 26 and 4[00000060-4:000000Bf-4] indicates the restructure unexecuted region 27.

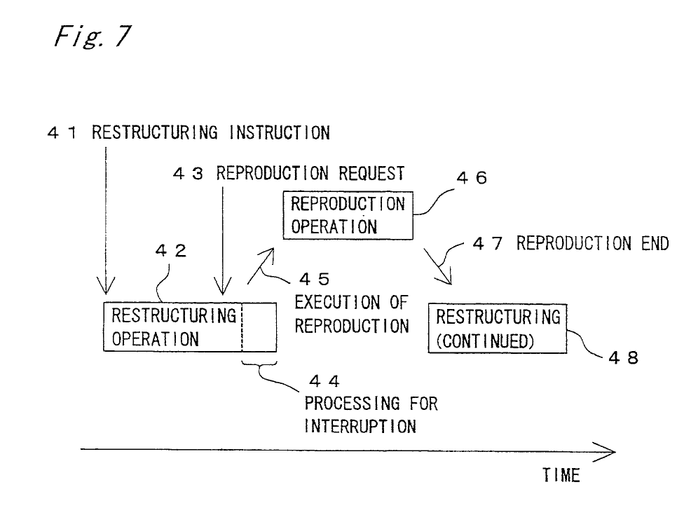

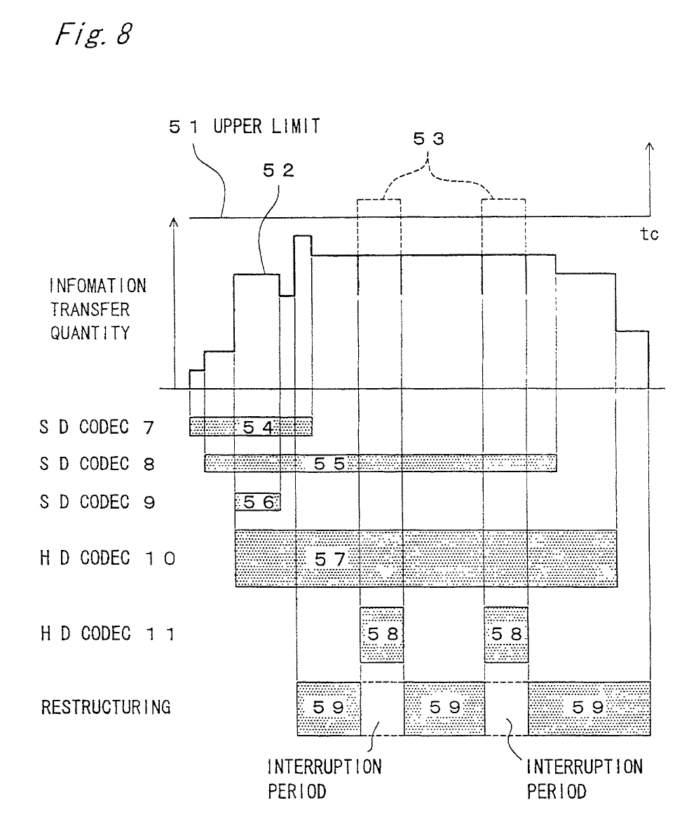

In such a restructure halfway state in which restructuring is being carried out, if there is issued a request for reproducing the storage information from a CODEC terminal, the management terminal 1 passes the information displayed on the region display portion 29 during the restructuring operation, in response to the CODEC terminal which issued the reproduction request. The CODEC terminals access the frames 01 to 23 in the restructure completed portion 26 regarding the HDD arrays as a type of eight magnetic disk devices including the added HDD arrays, and access the frames 24 to 44 in the restructure unexecuted region 27 regarding the HDD arrays as a type of four magnetic disk devices in a state before adding the magnetic disk devices while interrupting the restructuring operation. The interruption of the restructuring operation will be described later with reference to FIGS. 7 and 8. When the CODEC terminals finish the reproduction operation, the interruption is released and the restructuring operation is resumed and continued.

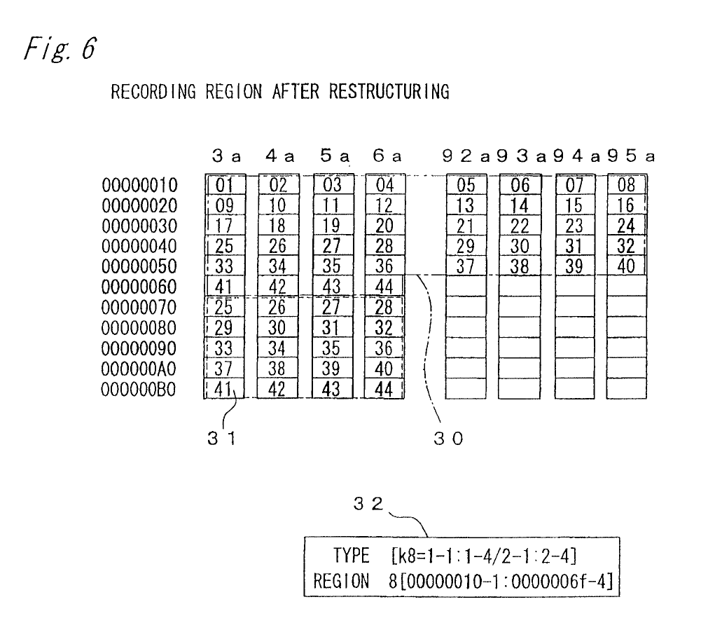

Next, with reference to FIG. 6, description will be given to a restructure completion state in which HDD arrays are extended to the high-speed AV information server and the storage information restructuring operation of the server has been completed. FIG. 6 shows a restructure completion state of the recording regions when the HDD arrays are extended to the high-speed AV information server and the storage information restructuring operation of the server has been completed. In FIG. 6, reference numeral 30 denotes a restructure completion region in which the restructure completed frames of the storage information are recorded. Reference numeral 31 denotes a recordable (or writable) region. While the previous storage frames 25 to 44 before the restructuring operation are already read and rearranged into the restructure completed region 30, although the previous storage information of these frames 25 to 44 remains in the recordable region 31, this region 31 is recognized as a writable region in which further data can be recorded when further recording is executed. Reference numeral 32 denotes a display of a region recording the storage AV information of 44 frames after completion of the restructuring operation.

The region display 32 displays that the type of the magnetic disk devices is used as the constitution of eight HDD arrays including the added HDD arrays with reference to [k8=1-1:1-4/2-1:2-4] and that the recording region of the storage information is the restructuring operation region 30 with reference to 8[00000010-1:0000003f-7].

In this construction of the server, if restructuring target information is not collectively located in one region, the information might be lost by overwrite during the restructuring operation, and therefore it is necessary to take any way of securing the information collectively. However, since this is not a subject matter of the present invention, description thereof is omitted here.

Next, referring to FIG. 7, description will be given to a restructure interruption state in which the restructuring operation of storage information is interrupted after HDD arrays are extended to the high-speed AV information server.

In FIG. 7, when HDD arrays are extended, the fact of extending the HDD arrays is inputted to the management terminal 1. Then, a restructuring instruction 41 is generated by a restructuring indication operation and a restructuring operation 42 is executed by the management terminal 1. If a CODEC terminal issues a reproduction request 43 for reading the storage information which is now under subjecting a restructuring operation, then an interruption request flag is built and an information processing 44 for interruption of restructure is carried out and the information of the restructure halfway state shown by the region display 29 (see FIG. 5) is passed as a reproduction instruction (45) to the CODEC terminal which has issued the reproduction request so as to instruct the CODEC terminal to reproduce the requested storage information.

In more detail, the information shown by the region display 29 (see FIG. 5) created in the process 44 for interruption and the restructuring operation is interrupted and the operation is changed to the reproduction execution (45). Based on the information shown by the region display 29 (see FIG. 5), the information under subjecting the restructuring operation is reproduced (46). In this reproduction operation (46), the information of the frames 01 to 23 is sequentially read and reproduced from the restructure completed region 26 (FIG. 5) and then the information of the frames 24 to 44 is sequentially read and reproduced from the unexecuted region 27 (see FIG. 5). When the CODEC terminal finishes the reproduction operation, a notification 47 of the reproduction completion is fed to the management terminal. Then, the interruption of the restructuring operation is released and the restructuring operation (continued) 48 is resumed and executed again.

Next, with reference to FIG. 8, description will be given to a restructure interruption state in which the restructuring operation of storage information is interrupted due to a limitation of the information transfer quantity after extending HDD arrays to the high-speed AV information server.

In FIG. 8, an upper limit 51 of information transfer quantity is defined when, for example, three SD CODEC terminals 7 to 9 and two HD CODEC terminals 10 and 11 are simultaneously operated. In the high-speed AV information server acting as an AV information recording and reproduction apparatus, the information transfer quantity of the HDD arrays is designed assuming a case where installed CODEC terminals are simultaneously operated. Information transfer quantity 52 shows total information transfer quantity when one or more CODEC terminals are operated. Operation bars 54 to 58 show the operating states of the respective CODEC terminals. Each of the HD CODEC terminals has large information transfer quantity and the quantity is, therefore, indicated by a thicker bar than that of each SD CODEC terminal.

An operating bar 59 shows that the restructuring operation is executed. The restructuring operation is the transfer of information between the memory of the management terminal 1 and the HDD arrays of the magnetic disk devices. Since the high-speed information transfer is possible by the server, the information transfer quantity in the restructuring operation is shown by the same thick as that of the high-vision mode (HD) transfer in the embodiment of the present invention. In FIG. 8, if a restructuring operation is continued (depicted by a dotted line) when there is an operation bar 58 requesting for operating the HD CODEC 11, the information transfer quantity 53 exceeds the upper limit 51. Therefore, the restructuring operation is interrupted. During the restructuring operation, the upper limit 51 of the information transfer quantity is set at a constant value specified before the magnetic disk devices are extended. After a restructure completion time point tc, the upper limit of the information transfer quantity abruptly increases.

According to the high-speed AV information server and the magnetic disk device extension method thereof according to the present invention are constituted as stated above. If a recording or reproduction request is excessively issued from a CODEC terminal during a restructuring operation after magnetic disk devices are extended to a server, the restructuring operation is automatically interrupted even while the recorded information is under subjecting a restructuring operation. Thus, it is possible to obtain favorable advantage of being capable of conducting recording and reproduction operations from the CODEC terminals without recognizing the restructuring operation.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

The present disclosure relates to subject matter contained in priority Japanese Patent Application No. 2000-16603, filed on Jan. 26, 2000, the contents of which is herein expressly incorporated by reference in its entirety.

What is claimed is:

1. A high-speed AV information server comprising:
a plurality of magnetic disk devices having recording regions storing AV information in division state inputted by way of a communication switching device;
at least one CODEC terminals for inputting and outputting the AV information to and from the magnetic disk devices; and
a management terminal controlling the magnetic disk devices and CODEC terminals and managing the recording regions of the magnetic disk devices;
wherein the management terminal includes:
a restructuring unit executing a restructuring operation of the AV information when another magnetic disk device is additionally extended; and
an interruption processing unit for interrupting the restructuring operation when a reproduction request is issued from one of the CODEC terminals to the storage information which is under being restructured.

2. The high-speed AV information server as claimed in claim 1, wherein each of the CODEC terminals converts an inputted analog AV information signal into a digital information signal and divides and records the digital information in the magnetic disk devices based on management information of the management terminal, and reads the digital information divided and recorded in the magnetic disk devices, converting the digital information into an analog information signal to be outputted.

3. The high-speed AV information server as claimed in claim 1, wherein the communication switching device switchably connecting the management terminal, magnetic disk devices and CODEC terminals.

4. The high-speed AV information server as claimed in claim 1, wherein the restructuring unit executes the restructuring operation, so that the AV digital information recorded in the magnetic disk devices before extending another magnetic disk device is divided and recorded into all of the magnetic disk devices including the extended magnetic disk device.

5. The high-speed AV information server as claimed in claim 1, wherein, during the interruption of the restructuring operation when a reproduction request is issued, the AV storage digital information divided and recorded in a restructure completed region and in a restructure unexecuted region of all the magnetic disk devices are read and fed to the CODEC terminal.

6. The high-speed AV information server as claimed in claim 1 further comprising a restructure resuming unit for resuming the interrupted restructuring operation to be continued when completing the requested reproduction operation.

7. The high-speed AV information server as claimed in claim 1, wherein the management terminal includes:
an information transfer quantity setting unit for setting an upper limit of information transfer quantity from information transfer quantity of each CODEC terminal and setting an information transfer quantity required for the restructuring operation under management of the management terminal.

8. The high-speed AV information server as claimed in claim 7, wherein, if total information transfer quantity of the information transfer quantity by operation of the CODEC terminals and the information transfer quantity by the restructuring operation exceeds the upper limit during the restructuring operation, then the restructuring operation is interrupted to respond to the operation request from the CODEC terminal.

9. A method of extending a magnetic disk device to a high-speed AV information server comprising:
storing AV information to a plurality of magnetic disk devices in division state;
inputting and outputting the AV information to and from the magnetic disk devices; and
executing a restructuring operation of the AV information when another magnetic disk device is additionally extended; and
interrupting the restructuring operation when a reproduction request is issued to the storage information which is under being restructured.

10. The method as claimed in claim 9, comprising the steps of converting an inputted analog AV information signal into a digital information signal and dividing and recording the digital information in the magnetic disk devices based on management information of a management terminal, and reading the digital information divided and recorded in the magnetic disk devices, converting the digital information into an analog information signal to be outputted.

11. The method as claimed in claim 9, wherein the restructuring step executes the restructuring operation, so that the AV digital information recorded in the magnetic disk devices before extending another magnetic disk device is divided and recorded into all of the magnetic disk devices including the extended magnetic disk device.

12. The method as claimed in claim 9, wherein, during the interruption of the restructuring operation when a reproduction request is issued, the method reads the AV storage digital information divided and recorded in a restructure completed region and in a restructure unexecuted region of all the magnetic disk devices.

13. The method as claimed in claim 9 further comprising a restructure resuming step for resuming the interrupted restructuring operation to be continued when completing the requested reproduction operation.

14. The method as claimed in claim 9 further including:
an information transfer quantity setting step for setting an upper limit of information transfer quantity from information transfer quantity and setting an information transfer quantity required for the restructuring operation under management of the management terminal.

15. The method as claimed in claim 14, wherein, if total information transfer quantity of the information transfer quantity by accessing and the information transfer quantity by the restructuring operation exceeds the upper limit during the restructuring operation, then the restructuring operation is interrupted to respond to the operation request.
